(19) United States
(12) Patent Application Publication
(10) Pub. No.: US 2003/0083123 A1
(43) Pub. Date: May 1, 2003

(54) Gaming machine

(75) Inventor: Jason Meyer, Abbotsford (AU)

Correspondence Address: PILLSBURY WINTHROP, LLP, P.O. BOX 10500, MCLEAN, VA, 22102, US

(73) Assignee: AINSWORTH GAME TECHNOLOGY LIMITED, Chiswick (AU)

(21) Appl. No.: 10/284,354

(22) Filed: Oct. 31, 2002

(30) Foreign Application Priority Data
Oct. 31, 2001 (AU) PR8592

(51) Int. Cl. A63F 9/24; A63F 13/00; G06F 17/00; G06F 19/00

(52) U.S. Cl. 463/20

(57) ABSTRACT

A gaming machine that operates a base game 1 and a feature game 2, 4. The feature game offers a range of possible benefits 4 such a prizes or beneficial alterations to the operation of the base game 1. The particular benefits chosen are a random selection 2 from the available range 4. The randomly selected benefits 5 may themselves interact with each other to provide a particularly generous prize or benefit to the player. The ability of the gaming machine to display very generous prizes is an attraction for players to select the gaming machine. However, the random selection process controls the frequency of awarding the generous prizes so as not to overly diminish the frequency of winning combinations in the base game 1 which may generate disinterest in the player.

### FIELD OF THE INVENTION

The present invention relates to gaming machines. The invention has been developed primarily for computerised gaming machines and will be described herein with reference to that application. However, the invention is not limited to that particular field of use and may be suitable for other applications such as gaming facilitated via the Internet.

### BACKGROUND OF THE INVENTION

Gaming machines have long been known and are now one of the most common forms of gambling. Usually gaming machines will simulate a well known game of chance. One of the oldest and best known forms of gaming machines is the rotating reel type “poker machine”. In light of its popularity, the present invention will be described with reference to this type of gaming machine. However, it will be appreciated that it is equally applicable to gaming machines other than the “rotating reel” type.

Traditional poker machines use a series of three or more reels, each reel having symbols on its peripheral edge. The reels are rotated upon the placement of a bet and then stopped to produce an arrangement of randomly selected symbols. Winnings are paid if the random selection of symbols matches one of the predetermined winning combinations. More recently, these gaming machines have been computerised with a video screen replacing the physically rotating reels. The display screen typically presents an array of symbols in five columns and three rows equating to the symbols that would normally be seen on the five physically rotating reels of an old style mechanical machine.

Gaming machines can “pay winnings” in a variety of ways. These include dispensing money, dispensing tokens that can be redeemed for money, or simply adding credits to a credit meter that can be used for placing future bets or redeemed as money. Given the predominance of computerised gaming machines, winnings are most commonly awarded in the form of credits tallied on a credit meter. However, those commonly awarded in the form of credits tallied on a credit meter. However, those skilled in the art will readily understand that the term encompasses other award payment mechanisms.

Computerised machines have allowed players to simultaneously bet on the combination of symbols appearing in many different parts of the array. These parts of the array are often referred to as “paylines” and consist of lines of adjacent symbols extending through the array. The symbols may be laterally adjacent each other (as in, from the same row) or diagonally adjacent each other. Therefore, paylines can extend along each row and various angled or ‘zig zag’ lines through the array instead of just the middle row which was traditionally the only payline available in the old style mechanical machines.

Most computerised gaming machines will offer at least five paylines in a five reel array. Eventually, all the practical paylines in the five column, three row array were being made available for players on most machines.

In an ongoing effort to maintain the player's interest, many machines now offer secondary or “feature” games. The feature appears upon some trigger event such as a predetermined outcome in the primary or “base” game. The feature can be used to provide the player with relatively large winnings and thereby provides a strong incentive to continue playing the machine. However, a particularly generous feature will require the machine to pay less winnings during the base game or be configured so that the feature occurs relatively infrequently. In both situations there is a risk that the player will lose interest and discontinue playing the machine.

### SUMMARY OF THE INVENTION

It is an object of the present invention to overcome or ameliorate at least one of the disadvantages of the prior art, or to provide a useful alternative.

According to a first aspect, the present invention provides a gaming machine adapted to display a base game of chance with random outcomes and pay winnings on predetermined winning outcomes; and

in response to a trigger event, a feature initiates in which a benefit is added or applied to the operation of the base game; wherein,

the benefit is randomly selected from a range of benefits.

According to another aspect, the present invention provides a method of operating a gaming machine including the steps of:

displaying a base game of chance with random outcomes and paying winnings on predetermined winning outcomes; and

initiating a feature in response to a trigger event, the feature adding or applying a benefit to the operation of the base game; wherein

the benefit is randomly selected from a range of benefits.

Preferably, two or more benefits are randomly selected from the range of benefits in response to the trigger event, and added or applied to the operation of the base game. In a further preferred form, the feature is configured such that at least two benefits in the range will interact when both are randomly selected to provide a compound benefit that exceeds the cumulative effect of the two or more benefits taken individually.

In preferred embodiments, the types of benefit include:

a set amount of additional winnings that are added to the winnings of the base game;

a predetermined number of free operating cycles of the base game wherein the base game operates and pays winnings on the occurrence of any of the winning outcomes without first requiring the placement of a bet; and

the multiplication of winnings from the base game by a multiplying factor.

In a particularly desirable embodiment for players, the feature is configured such that when two or more predetermined multiplying factors are randomly selected from the types of benefit available, the factors are themselves multiplied together to produce a number which is then used to multiply any winnings from the base game.

In one embodiment, the feature is configured to randomly select three benefits from the range, and the range includes ten benefits. Conveniently, the random selection is displayed on a simulated reel with numbers on its peripheral edge that correspond to benefits in the range, wherein the display simulates the reel being spun and then brought to rest such that the symbols shown when the reel comes to rest correspond to the random selection of benefits. In a particularly convenient form, the base game presents an array of symbols selected randomly from a set of symbols wherein the winnings are paid on predetermined winning combinations appearing in a portion of the array carrying a bet.

Using the present invention, the gaming machine can offer features that are extremely generous and this provides a strong motivation for players to select these machines. However, by offering a feature that randomly selects from a range of benefits, the probability of a highly generous return to the player is controlled without overly affecting the triggering frequency of the feature. This serves to maintain player interest once the machine has been selected.

### BRIEF DESCRIPTION OF THE DRAWINGS

A preferred embodiment of the invention will now be described, by way of example only, with reference to the accompanying drawings in which:

FIG. 1 is a schematic representation of the display screen during the operation of the base game; and

FIG. 2 is a schematic representation of the display screen during the operation of the feature.

### DETAILED DESCRIPTION OF THE PREFERRED EMBODIMENTS

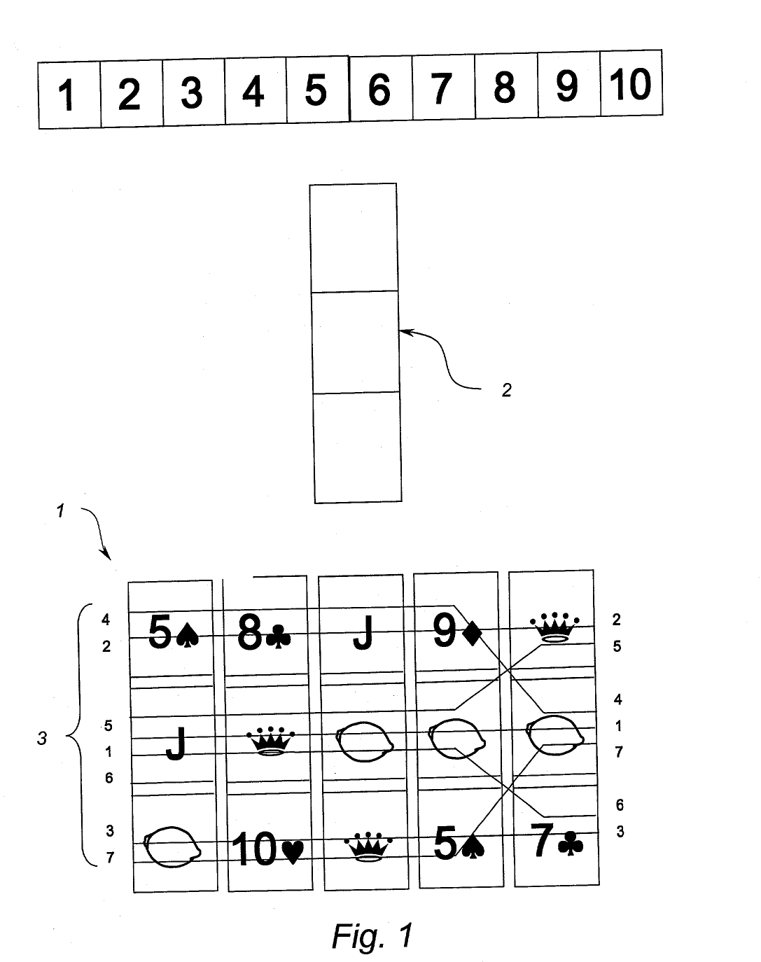

Referring to FIG. 1, the base game mode of operation of the gaming machine is shown. The base game presents an array 1 of symbols in five columns and three rows. The player is given the option of placing a bet on any or all of the seven different paylines 3. Upon the occurrence of a specified winning combination on any of the paylines carrying a bet, winnings are paid, usually in the form of credits added to the credit meter (not shown).

In order to initiate the feature, certain outcomes in the base game 1 may be designated as trigger events. For example, the occurrence of four of the lemon symbols anywhere in the array 1 (known as a scatter) may be one of the designated trigger events.

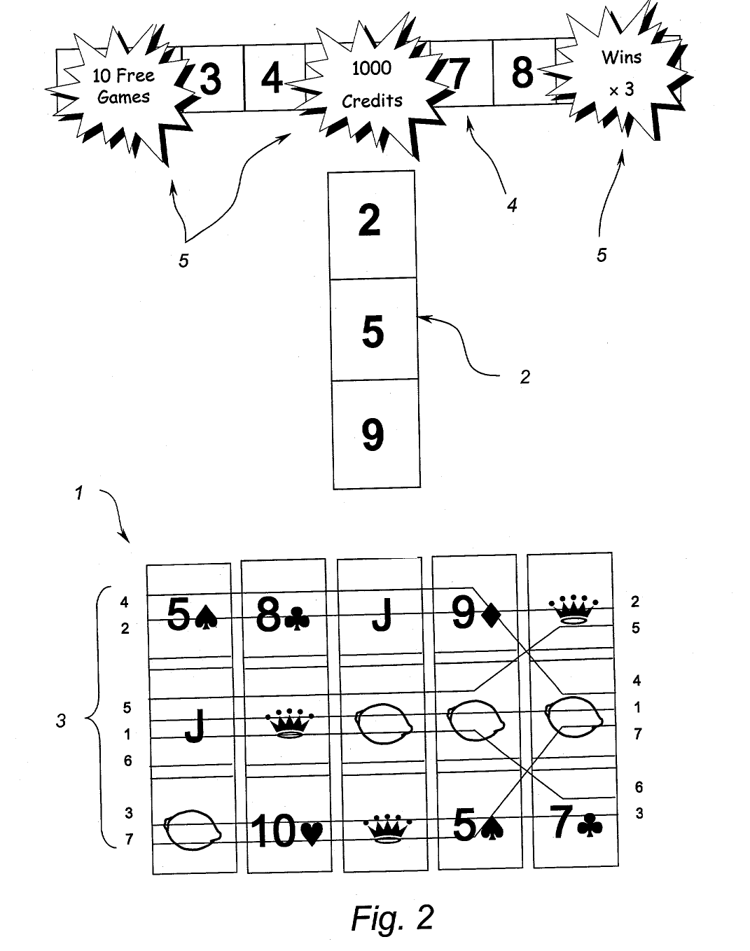

As shown in FIG. 2, once the feature is triggered a separate array of symbols 2 is shown as a simulation of a single reel. The simulated reel 2 is spun in order to randomly select the benefits from the ten different types of available benefits. The display screen includes an array of numbered boxes 4 representing the different types of feature benefits available. Once the feature reel 2 has randomly selected the numbers corresponding to the particular type of benefit that will be awarded to the player the display screen can reveal these benefits in an animated way to visually reinforce the sense of bonus in the player.

The benefits or bonus prizes range from a fairly modest bonus to very generous prizes of great value to the player. Examples of typical prizes would be ten free games, all wins in the base game doubled or tripled, ‘held’ reels in the base game (for rotating reel games) or simply 1000 bonus credits. Each of the bonus prizes may be revealed with an individualised animation such that the more valuable prizes are presented more dynamically than prizes of less value.

As the bonus reel 2 selects three numbers, it is possible to pick three different bonus prizes 4 per game. However, to encourage players to bet on all the available paylines 3 in the base game 1, the machine can be configured such that it only awards the player the highest value bonus prize when the trigger occurs in a base game where three or less paylines were carrying a bet. If four or five of the paylines 3 were carrying a bet, then the machine can award the more valuable two of the three randomly bonus prizes. If six or seven of the available paylines 3 were carrying a bet then the player receives all three of the randomly selected bonus prizes 4.

This can provide particularly strong incentive if two or more of the bonus prizes 4 are multiplying factors that, say, double or treble any wins in the base game 1. Furthermore, the machine can be configured so that when two or more of the randomly selected bonus prizes are multiplying factors, then the multiplying factors are themselves multiplied together, and the product is then used to multiply any winnings in the base game 1. Obviously this can yield very high returns for the player as the potential winnings are greater than if the base game winnings were separately multiplied by the respective multiplying factors and then simply added together.

The available benefits or bonus prizes may be very generous and this can be prominently displayed on the machine. However, the bonus reel 2 can be used to ensure that the particularly high value prizes are selected infrequently enough to allow the base game 1 to maintain a reasonable frequency of winning combinations. Using this, the display of the highly generous potential bonus prizes initially attracts players, however, the frequency of wins in the base game, or triggering of the feature game, is high enough to sustain the players interest.

The present invention has been described herein by way of example only. Skilled workers in this field will readily recognise many variations and modifications which do not depart from the spirit and scope of the broad inventive concept.

We claim:

1. A gaming machine adapted to display a base game of chance with random outcomes and pay winnings on predetermined winning outcomes; and
in response to a trigger event, a feature initiates in which a benefit is added or applied to the operation of the base game; wherein,
the benefit is randomly selected from a range of benefits.

2. A gaming machine according to claim 1, wherein two or more benefits are randomly selected from the range of benefits in response to the trigger event, and added or applied to the operation of the base game.

3. A gaming machine according to claim 2, wherein the feature is configured such that at least two benefits in the range will interact when both are randomly selected to provide a compound benefit that exceeds the cumulative effect of the two or more benefits taken individually.

4. A gaming machine according to any of claim 1, wherein the types of benefit include:
a set amount of additional winnings that are added to the winnings of the base game;
a predetermined number of free operating cycles of the base game wherein the base game operates and pays winnings on the occurrence of any of the winning outcomes without first requiring the placement of a bet; and
the multiplication of winnings from the base game by a multiplying factor.

5. A gaming machine according to claim 4, wherein the feature is configured such that when two or more predetermined multiplying factors are randomly selected from the types of benefit available, the factors are themselves multiplied together to produce a number which is then used to multiply any winnings from the base game.

6. A gaming machine according to claim 5, wherein the feature is configured to randomly select three benefits from the range, and the range includes ten benefits.

7. A gaming machine according to claim 6, wherein the random selection is displayed on a simulated reel with numbers on its peripheral edge that correspond to the benefits in the range, wherein the display simulates the reel being spun and then brought to rest such that the symbols shown when the reel comes to rest correspond to the random selection of benefits.

8. A gaming machine according to any of claims 1 to 7, wherein the base game presents an array of symbols selected randomly from a set of symbols wherein the winnings are paid on predetermined winning combinations appearing in a portion of the array carrying a bet.

9. A method of operating a gaming machine including the steps of:
displaying a base game of chance with random outcomes and paying winnings on predetermined winning outcomes; and
initiating a feature in response to a trigger event, the feature adding or applying a benefit to the operation of the base game; wherein
the benefit is randomly selected from a range of benefits.

10. A method of operating a gaming machine according to claim 9, wherein two or more benefits are randomly selected from the range of benefits in response to the trigger event, and added or applied to the operation of the base game.

11. A method of operating a gaming machine according to claim 10, wherein the feature is configured such that at least two benefits in the range will interact when both are randomly selected to provide a compound benefit that exceeds the cumulative effect of the two or more benefits taken individually.

12. A method of operating a gaming machine according to claim 11, wherein the types of benefit include:
a set amount of additional winnings that are added to the winnings of the base game;
a predetermined number of free operating cycles of the base game wherein the base game operates and pays winnings on the occurrence of any of the winning outcomes without first requiring the placement of a bet; and
the multiplication of winnings from the base game by a multiplying factor.

13. A method of operating a gaming machine according to claim 12, wherein the feature is configured such that when two or more predetermined multiplying factors are randomly selected from the types of benefit available, the factors are themselves multiplied together to produce a number which is then used to multiply any winnings from the base game.

14. A method of operating a gaming machine according to claim 13, wherein the feature is configured to randomly select three benefits from the range, and the range includes ten benefits.

15. A method of operating a gaming machine according to claim 14, wherein the random selection is displayed on a simulated reel with numbers on its peripheral edge that correspond to the benefits in the range, wherein the display simulates the reel being spun and then brought to rest such that the symbols shown when the reel comes to rest correspond to the random selection of benefits.

16. A method of operating a gaming machine according to any one of claims 9 to 15, wherein the base game presents an array of symbols selected randomly from a set of symbols wherein the winnings are paid on predetermined winning combinations appearing in a portion of the array carrying is bet.
